(19) United States
(12) Patent Application Publication
(10) Pub. No.: US 2025/0370485 A1
(43) Pub. Date: Dec. 4, 2025

(54) VALVE CONTROL DEVICE, VALVE CONTROL METHOD, VALVE CONTROL PROGRAM, AND FLUID CONTROL DEVICE

(71) Applicant: HORIBA STEC, Co., Ltd., Kyoto-shi, Kyoto (JP)

(72) Inventors: Kazuya TOKUNAGA, Kyoto-shi (JP); Kotaro TAKIJIRI, Kyoto-shi (JP)

(21) Appl. No.: 18/681,377

(22) PCT Filed: Jul. 14, 2022
(86) PCT No.: PCT/JP2022/027715

§ 371 Date: Mar. 14, 2025

(30) Foreign Application Priority Data
Aug. 6, 2021 (JP) 2021-129775

(51) Int. Cl. G05D 7/06; G01F 1/34

(52) U.S. Cl. CPC G05D 7/0635; G01F 1/34

(57) ABSTRACT

To improve responsiveness while reducing the effect of noise, a valve control method for controlling a valve of a fluid control device includes generating a target response function converted from the flow rate setting using a target response transfer function; generating a target voltage function by making a correction in nonlinearity of a drive voltage for the valve and a flow rate, with respect to the target response function; generating a feedforward voltage signal from the target voltage function by making a correction corresponding to the delay characteristic of the valve; causing a feedback controller to generate a feedback voltage signal from a deviation between the target response function and a flow rate measurement of a flow rate sensor; generating a corrected command voltage signal using a feedforward voltage signal and the feedback voltage signal; and controlling the valve using the corrected command voltage signal.

### TECHNICAL FIELD

The present invention relates to a valve control device, a valve control method, a valve control program, and a fluid control device.

### BACKGROUND ART

A conventional fluid control device (also referred to as a mass flow controller) includes, as disclosed in Patent Literature 1, a flow rate sensor that measures a flow rate of the fluid flowing through a channel, a valve provided inside the channel, and a flow rate control unit that controls the flow using the valve, based on the flow rate measurement obtained by the flow rate sensor and a flow rate setting.

Such a mass flow controller is configured to focus on the time delay in a flow rate measurement measured by the flow rate sensor, to prevent issues such as an overshoot caused by the time delay. Specifically, the flow rate control unit includes a sensor model storage unit that stores therein a sensor model with which the response characteristic of the flow rate sensor is simulated, a simulated flow rate output unit that outputs a simulated flow rate calculated on the basis of a flow rate setting and the sensor model, a feedback control unit that outputs a flow rate feedback on the basis of a deviation between a flow rate measurement and the simulated flow rate, and a valve control unit that controls the valve on the basis of a flow rate feedforward calculated from the flow rate setting, and of the flow rate feedback.

### CITATION LIST

### Patent Literature

Patent Literature 1: JP 6423792 B2

### SUMMARY OF INVENTION

### Technical Problem

However, merely by addressing the time delay of the flow rate measurement, measured by the flow rate sensor, as described above, improvement in the responsiveness is still challenging, due to the delay characteristics of the driving circuit for driving the valve. In addition, noise is superimposed on the flow rate measurement. As one possible solution for reducing the effect of such noise while enabling feedback control, a low-pass filter or the like may be added to add a delay to the PID controller, but such an addition causes a deterioration in the step responsiveness.

The present invention has been made in consideration of the problems described above, and a main object of the present invention is to improve the responsiveness while reducing the effect of noise, in the valve control of a fluid control device.

### Solution to Problem

In other words, a valve control device according to the present invention is a valve control device for controlling a valve of a fluid control device, the valve control device including: a target voltage function generation unit that generates a target voltage function by making a correction in nonlinearity of a drive voltage for the valve and a flow rate, with respect to an input flow rate setting or a target response function converted from the flow rate setting using a target response transfer function; a feedforward voltage signal generation unit that generates a feedforward voltage signal from the target voltage function, by making a correction corresponding to a delay characteristic of the valve; a feedback voltage signal generation unit that causes a feedback controller to generate a feedback voltage signal from a deviation between the target response function and a flow rate measurement of a flow rate sensor; and a voltage command output unit that generates a corrected command voltage signal using the feedforward voltage signal and the feedback voltage signal, and outputs a resultant voltage command to a driving circuit of the valve.

In such a valve control device, because the target voltage function is generated by making a correction in the nonlinearity of the drive voltage of the valve and the flow rate, with respect to the flow rate setting or the target response function converted from the flow rate setting using the target response transfer function, and the feedforward voltage signal is generated from the target voltage function by making a correction corresponding to the delay characteristic of the valve, responsiveness to step inputs can be improved. In other words, the order of: generating the target response function; making a correction in the nonlinearity of the valve; and correcting the delay of the valve is exactly reverse of the functional blocks in the actual system. It is therefore possible to correct a change in the behavior of the delay element caused by such a nonlinearity, appropriately, and to improve the responsiveness to step inputs. In the present invention, the feedforward voltage signal is generated by making a correction corresponding to the delay characteristic of the valve from the target voltage function, without correcting the delay characteristic of the valve in the feedback control loop of the feedback controller. Therefore, it is possible to reduce the effect of the noise superimposed on the flow rate measurement.

In addition, because the feedback controller is used to generate the feedback voltage signal from the deviation of the flow rate measurement of the flow rate sensor with respect to the flow rate setting or the target response function, which is converted from the flow rate setting using the target response transfer function, there is no concern for deterioration in the accuracy of the flow rate.

Furthermore, because the target response transfer function and the feedback transfer function of the feedback controller can be adjusted separately, it is possible to improve the responsiveness to in the valve control.

The valve control device according to the present invention preferably further includes a target response function generation unit that generates the target response function from the flow rate setting using the target response transfer function.

As a specific embodiment of the feedback controller, an integral controller is preferably included.

A valve control method according to the present invention is a valve control method for controlling a valve of a fluid control device, the valve control method including: generating a target voltage function by making a correction in nonlinearity of a drive voltage for the valve and a flow rate, with respect to an input flow rate setting or a target response function converted from the flow rate setting using a target response transfer function; generating a feedforward voltage signal from the target voltage function, by making a correction corresponding to a delay characteristic of the valve; causing a feedback controller to generate a feedback voltage signal from a deviation between the target response function and a flow rate measurement of a flow rate sensor; and generating a corrected command voltage signal using the feedforward voltage signal and the feedback voltage signal, and controlling the valve using the corrected command voltage signal.

Furthermore, a fluid control device according to the present invention includes: a flow rate sensor configured to measure a flow rate of a fluid flowing through a channel; a flow rate control valve provided upstream or downstream of the flow rate sensor; and the above-described valve control device that controls the flow rate control valve.

In order to improve the fluid control performance of the fluid control device, preferably, two flow rate control valves are provided in the channel.

In this configuration, in order to enhance the effect of the present invention, the flow rate sensor is preferably a pressure flow rate sensor.

Furthermore, a valve control program according to the present invention is a valve control program for controlling a valve of a fluid control device, the valve control program causing a computer to execute functions of: generating a target voltage function by making a correction in nonlinearity of a drive voltage for the valve and a flow rate, with respect to an input flow rate setting or a target response function converted from the flow rate setting using a target response transfer function; generating a feedforward voltage signal from the target voltage function, by making a correction corresponding to a delay characteristic of the valve; causing a feedback transfer function to generate a feedback voltage signal from a deviation between the target response function and a flow rate measurement of a flow rate sensor; and generating a corrected command voltage signal using the feedforward voltage signal and the feedback voltage signal, and controlling the valve using the corrected command voltage signal.

### Advantageous Effects of Invention

According to the present invention described above, it is possible to improve the responsiveness while reducing the effect of noise, in the valve control performed by the fluid control device.

### BRIEF DESCRIPTION OF DRAWINGS

FIG. 1 is a schematic diagram of the overall fluid control system according to an embodiment of the present invention.

FIG. 2 is a block diagram illustrating control performed by a valve control device according to the embodiment.

FIG. 3 is a graph illustrating a controlled variable for a step response in the embodiment.

FIG. 4 is a graph illustrating a controlled variable for a step response in a conventional configuration.

FIG. 5 is a schematic diagram of the overall fluid control system according to a modification of the embodiment.

### DESCRIPTION OF EMBODIMENTS

A fluid control device according to one embodiment of the present invention will now be explained with reference to some drawings.

### 1. System Configuration

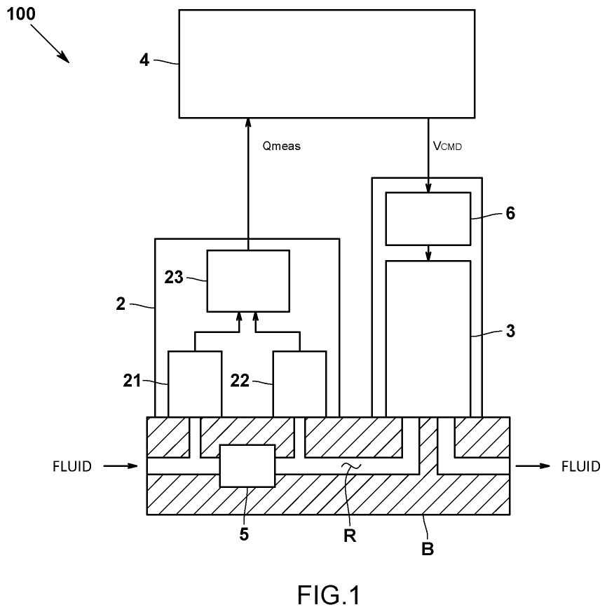

A fluid control device 100 according to this embodiment is used in processes such as a semiconductor manufacturing process, and includes, as illustrated in FIG. 1, a flow rate sensor 2 that measures a flow rate of a fluid flowing through a channel R formed inside a block B, a flow rate control valve 3 provided upstream or downstream of the flow rate sensor 2, and a valve control device 4 that controls the flow rate control valve 3.

The flow rate sensor 2 in this example is a differential pressure flow rate sensor. Specifically, the flow rate sensor 2 includes an upstream pressure sensor 21 provided inside the channel R upstream of a resistor element 5, such as a restrictor or an orifice, a downstream pressure sensor 22 provided downstream of the resistor element 5, and a flow rate calculation unit 23 that calculates a flow rate from a differential pressure between the two pressure sensors 21, 22. The flow rate calculation unit 23 may be incorporated in the valve control device 4.

The fluid control valve 3 is provided upstream of the differential pressure flow rate sensor 2. Specifically, the fluid control valve 3 controls the flow rate by advancing and retracting the valve body with respect to the valve seat, using the piezoelectric actuator. The drive voltage for the piezoelectric actuator is adjusted by a valve driving circuit 6.

### 2. Valve Control Device 4

The valve control device 4 controls the valve aperture of the fluid control valve 3 based on the flow rate measurement of the flow rate sensor 2 and a flow rate setting.

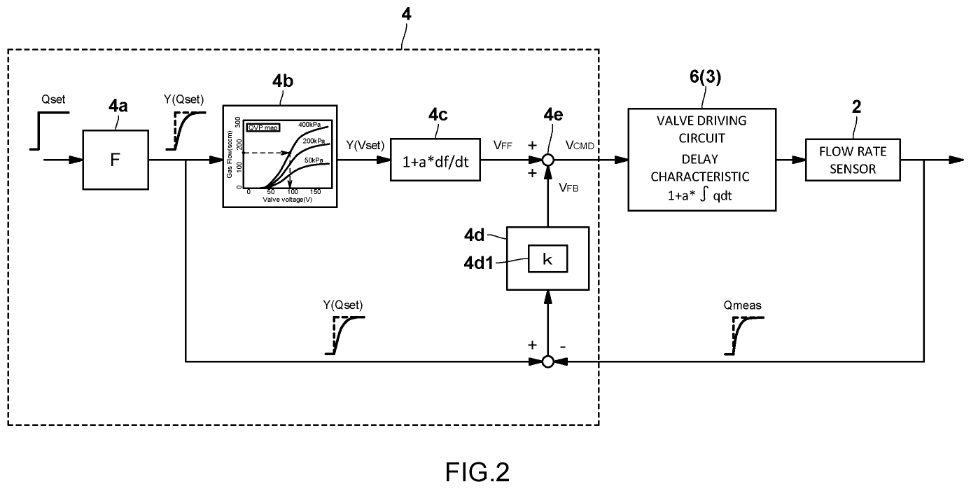

The valve control device 4 may be implemented by a computer that includes a CPU, an internal memory, an input/output interface, and an AD converter. By causing the CPU to cooperate with peripheral devices on the basis of a control program stored in the internal memory, the valve control device 4 functions as, as illustrated in FIG. 2, a target response function generation unit 4a, a target voltage function generation unit 4b, a feedforward voltage signal generation unit 4c, a feedback voltage signal generation unit 4d, and a voltage command output unit 4e.

The target response function generation unit 4a generates a target response function Y(Qₛₑₜ) converted from the flow rate setting Qₛₑₜ using a target response transfer function F. The target response transfer function F herein is a transfer function modeling the fluid control valve 3 to be controlled, and, in this embodiment, is a transfer function modeling the valve driving circuit 6 for the fluid control valve 3.

The target voltage function generation unit 4b generates a target voltage function Y(Vₛₑₜ) by making a correction in nonlinearity of the drive voltage for the flow rate control valve 3 and the resultant flow rate, to the target response function Y(Qₛₑₜ). “Making a correction in the nonlinearity of the drive voltage applied to the flow rate control valve 3 and the resultant flow rate” herein means creating a target voltage function Y(Vₛₑₜ) corresponding to the target response function Y(Qₛₑₜ), by executing a reverse lookup on relational data (the data format may be either a lookup table or a formula) indicating a relationship between the drive voltage applied to the flow rate control valve 3 and the resultant flow rate.

The feedforward voltage signal generation unit 4c generates a feedforward voltage signal V_{FF} from the target voltage function Y(Vₛₑₜ), by making a correction corresponding to the delay characteristic of the flow rate control valve 3. The feedforward voltage signal generation unit 4c according to this embodiment is implemented using a low-pass filter, and configured to correct a delay characteristic that is a linear dynamic characteristic of the valve driving circuit 6. In other words, the feedforward voltage signal generation unit 4c adds an advance characteristic (1+a×df/dt) corresponding to the delay characteristic of the valve driving circuit 6, to the target voltage function Y(Vₛₑₜ).

The feedback voltage signal generation unit 4d causes a feedback controller 4d1 to generate a feedback voltage signal V_{FB} from a deviation between the target response function Y(Qₛₑₜ) and a flow rate measurement Qₘₑₐₛ of the flow rate sensor 2. The feedback controller 4d1 according to this embodiment at least includes an integral controller (feedback transfer function k).

The voltage command output unit 4e generates a corrected command voltage signal V_{CMD} using the feedforward voltage signal V_{FF} and the feedback voltage signal V_{FB}, and outputs the resultant voltage command to the valve driving circuit 6. In this embodiment, the corrected command voltage signal V_{CMD} is generated by taking the sum of the feedforward voltage signal V_{FF} and the feedback voltage signal V_{FB}.

When there is an extensive response delay or a high overshoot due to aging of the fluid control valve 3, the voltage command output unit 4e may also multiply the feedforward voltage signal V_{FF} by the feedback voltage signal V_{FB} to generate the corrected command voltage signal V_{CMD}. With this configuration, it is possible to improve the responsiveness and to suppress the overshoot. The voltage command output unit 4e may also include a switching unit being switched between the configuration that generates the corrected command voltage signal V_{CMD} by taking the sum of the feedforward voltage signal V_{FF} and the feedback voltage signal V_{FB}, and the configuration that generates the corrected command voltage signal V_{CMD} by multiplying the feedforward voltage signal V_{FF} by the feedback voltage signal V_{FB}. With this, it is possible to respond to various events flexibly.

A valve control method performed by the valve control device 4 configured as described above include: generating a target response function Y(Qₛₑₜ) from an input flow rate setting Qₛₑₜ using a target response transfer function F; generating a target voltage function Y(Vₛₑₜ) by making a correction in the nonlinearity of the drive voltage for the fluid control valve 3 and the flow rate, with respect to the target response function Y(Qₛₑₜ); generating a feedforward voltage signal V_{FF} from the target voltage function Y(Vₛₑₜ) by making a correction corresponding to the delay characteristic of the fluid control valve 3; causing the feedback controller 4d1 to generate a feedback voltage signal V_{FB} from a deviation between the target response function Y(Qₛₑₜ) and the flow rate measurement Qₘₑₐₛ of the flow rate sensor 2; generating a corrected command voltage signal V_{CMD} using the feedforward voltage signal V_{FF} and the feedback voltage signal V_{FB}; and controlling the fluid control valve 3 using the corrected command voltage signal V_{CMD}.

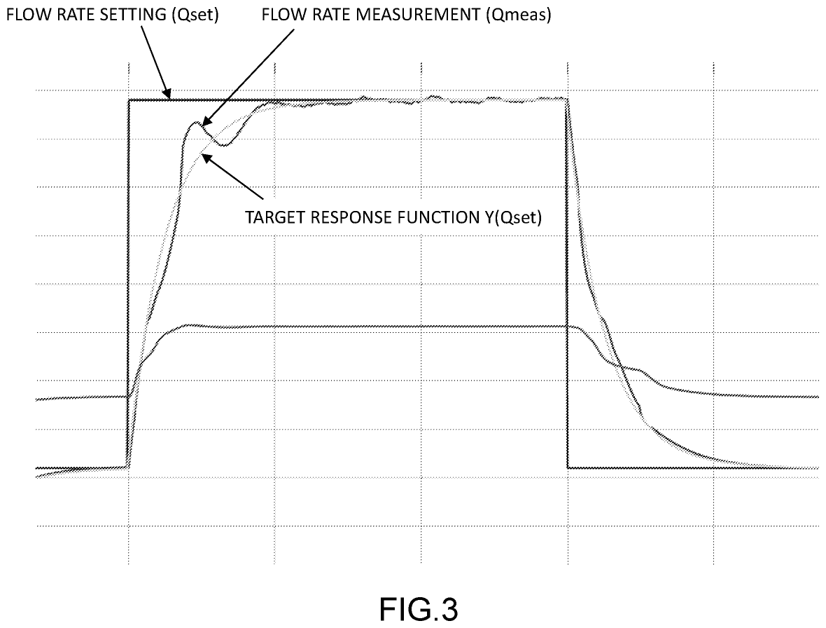

FIG. 3 illustrates responsiveness of the valve control device 4 having the configuration described above, achieved by using a step input as the flow rate setting. In this simulation, the full scale was set to 40 sccm; the upstream pressure was set to 450 kPaA; and the downstream pressure was set to 0 kPaA. In FIG. 3, it can be seen that the flow rate measurement Qₘₑₐₛ follows the target response function Y(Qₛₑₜ), and exhibits a better responsiveness to the step input.

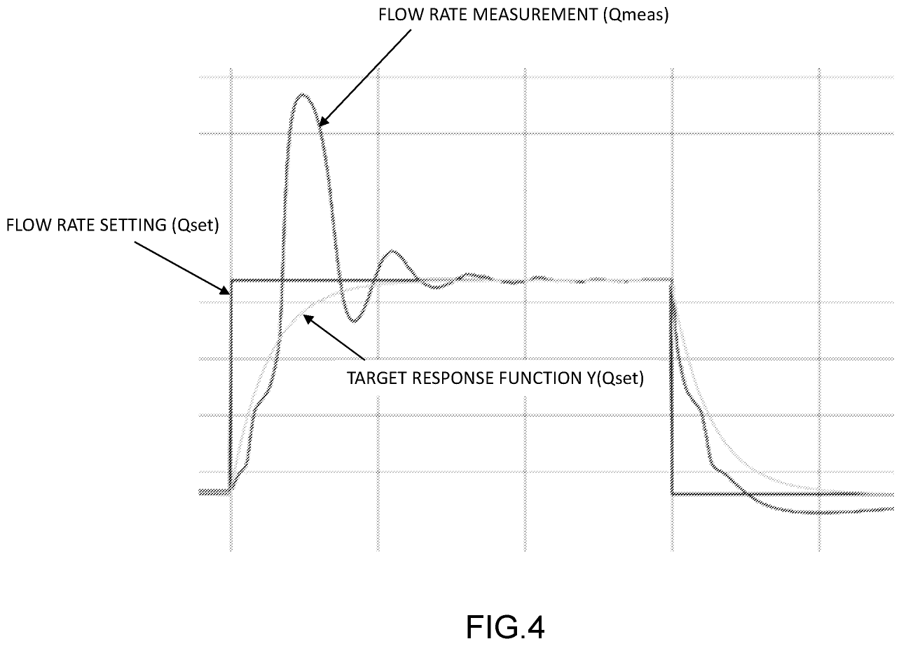

FIG. 4, by contrast, illustrates responsiveness of a valve control device having a conventional configuration, achieved by using a step input as the flow rate setting. Note that the valve control device with the conventional configuration has a configuration with the target response function generation unit 4a and the target voltage function generation unit 4b switched, in comparison with the configuration according to the embodiment. In FIG. 4, it can be seen that the flow rate measurement Qₘₑₐₛ, has an extensive overshoot, and exhibits poor responsiveness to the step input.

### 3. Advantageous Effects Achieved by This Embodiment

The fluid control device 100 according to this embodiment having the configuration described above generates the target voltage function Y(Vₛₑₜ) by making a correction in the nonlinearity of the drive voltage for the fluid control valve 3 and the flow rate, with respect to the target response function Y(Qₛₑₜ) converted from the flow rate setting using Qₛₑₜ using the target response transfer function F, and generates the feedforward voltage signal V_{FF} from the target voltage function Y(Vₛₑₜ) by making a correction corresponding to the delay characteristic of the fluid control valve 3. Therefore, responsiveness to step inputs can be improved. In other words, the order of: generating the target response function Y(Qₛₑₜ); making a correction in the nonlinearity of the valve 3; and correcting the delay of the valve driving circuit 6 is exactly reverse of the functional blocks in the actual system. It is therefore possible to correct a change in the behavior of the delay element caused by such a nonlinearity, appropriately, and to improve the responsiveness to step inputs. In this embodiment, the feedforward voltage signal V_{FF} is generated from the target voltage function Y(Vₛₑₜ) by making a correction corresponding to the delay characteristic of the fluid control valve 3, without correcting the delay characteristic of the fluid control valve 3 in the feedback control loop of the feedback controller 4d1. Therefore, it is possible to reduce the effect of the superimposed noise on the flow rate measurement.

In addition, because the feedback controller 4d1 generates the feedback voltage signal V_{FB} from the deviation between the target response function Y(Qₛₑₜ), which is converted from the flow rate setting Qₛₑₜ using the target response transfer function F, and the flow rate measurement Qₘₑₐₛ of the flow rate sensor 2, there is no concern for deterioration in the accuracy of the flow rate.

Furthermore, because the target response transfer function F and the feedback transfer function k of the feedback controller 4d1 can be adjusted separately, it is possible to improve the responsiveness to the step inputs in the valve control.

### 4. Other Embodiments

For example, in the above embodiment, the flow rate sensor is a pressure flow rate sensor, but may be a thermal flow rate sensor.

In addition, although the feedback controller according to the embodiment described above is an integral controller, it is also possible to include a proportional controller or a differential controller, instead of or in addition to the integral controller.

Furthermore, although the target response function generation unit 4a is provided in the above embodiment, the target response function generation unit 4a may be omitted. In other words, the target voltage function generation unit 4b may be configured generate the target voltage function by making a correction in the nonlinearity of the drive voltage applied to the valve and the flow rate, with respect to the input flow rate setting.

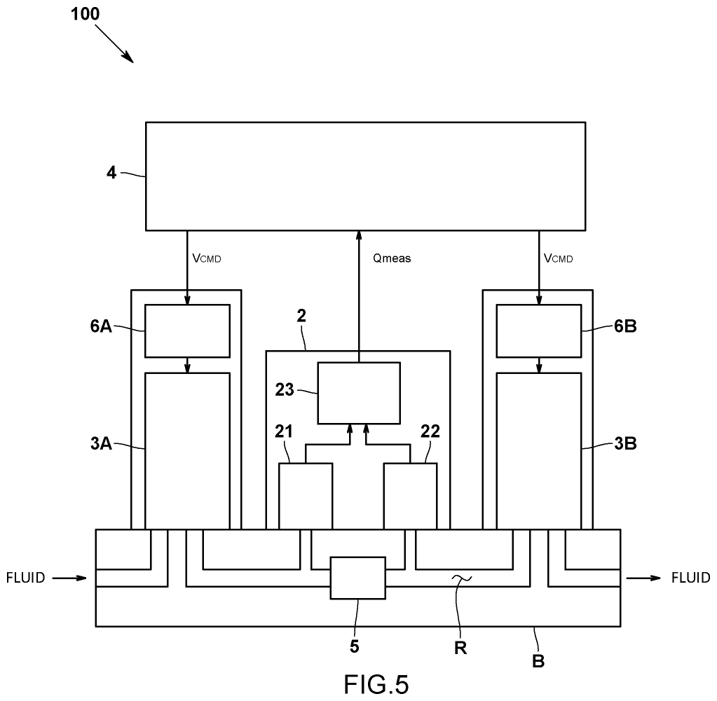

In addition, it is also possible to use a configuration including two fluid control valves 3A, 3B, as illustrated in FIG. 5. In such a configuration, the valve control device 4 may control the flow rate of both of the two fluid control valves 3A, 3B in the same manner as in the embodiment described above, or control the flow rate of the upstream fluid control valve 3A in the same manner as in the embodiment described above and control the pressure of the downstream fluid control valve 3B so as to bring the downstream pressure obtained by the downstream pressure sensor 22 closer to a predetermined target pressure.

Any other various modifications and combinations of the embodiment are still possible within the scope not deviating from the gist of the present invention.

### INDUSTRIAL APPLICABILITY

According to the present invention, it is possible to improve the responsiveness while reducing the effect of noise, in the valve control performed by the fluid control device.

### REFERENCE CHARACTERS LIST

100 fluid control device
2 flow rate sensor (pressure flow rate sensor)
3 flow rate control valve
4 valve control device
4a target response function generation unit
4b target voltage function generation unit
4c feedforward voltage signal generation unit
4d feedback voltage signal generation unit
4d1 feedback controller (integral controller)
4e voltage command output unit
5 resistor element
6 valve driving circuit

1. A valve control device for controlling a valve of a fluid control device, the valve control device comprising:
a target voltage function generation unit that generates a target voltage function by making a correction in nonlinearity of a drive voltage for the valve and a flow rate, with respect to an input flow rate setting or a target response function converted from the flow rate setting using a target response transfer function;
a feedforward voltage signal generation unit that generates a feedforward voltage signal from the target voltage function, by making a correction corresponding to a delay characteristic of the valve;
a feedback voltage signal generation unit that causes a feedback controller to generate a feedback voltage signal from a deviation between the target response function and a flow rate measurement of a flow rate sensor; and
a voltage command output unit that generates a corrected command voltage signal using the feedforward voltage signal and the feedback voltage signal, and outputs a resultant voltage command to a driving circuit of the valve.

2. The valve control device according to claim 1, further comprising a target response function generation unit that generates the target response function from the flow rate setting using the target response transfer function.

3. The valve control device according to claim 1, wherein the feedback controller includes an integral controller.

4. A valve control method for controlling a valve of a fluid control device, the valve control method comprising:
generating a target voltage function by making a correction in nonlinearity of a drive voltage for the valve and a flow rate, with respect to an input flow rate setting or a target response function converted from the flow rate setting using a target response transfer function;
generating a feedforward voltage signal from the target voltage function, by making a correction corresponding to a delay characteristic of the valve;
causing a feedback controller to generate a feedback voltage signal from a deviation between the target response function and a flow rate measurement of a flow rate sensor; and
generating a corrected command voltage signal using the feedforward voltage signal and the feedback voltage signal, and controlling the valve using the corrected command voltage signal.

5. A non-transitory computer-readable medium storing a valve control program for controlling a valve of a fluid control device, the valve control program executable by a computer to cause the a computer to execute functions of:
generating a target voltage function by making a correction in nonlinearity of a drive voltage for the valve and a flow rate, with respect to an input flow rate setting or a target response function converted from the flow rate setting using a target response transfer function;
generating a feedforward voltage signal from the target voltage function, by making a correction corresponding to a delay characteristic of the valve;
causing a feedback transfer function to generate a feedback voltage signal from a deviation between the target response function and a flow rate measurement of a flow rate sensor; and
generating a corrected command voltage signal using the feedforward voltage signal and the feedback voltage signal, and controlling the valve using the corrected command voltage signal.

6. A fluid control device comprising:
a flow rate sensor configured to measure a flow rate of a fluid flowing through a channel;
a flow rate control valve provided upstream or downstream of the flow rate sensor; and
the valve control device according to claim 1 that controls the flow rate control valve.

7. The fluid control device according to claim 6, wherein the flow rate control valve includes two flow rate control valves, and the two flow rate control valves are provided in the channel.

8. The fluid control device according to claim 6, wherein the flow rate sensor is a pressure flow rate sensor.
